(19) United States
(12) Patent Application Publication
(10) Pub. No.: US 2021/0262611 A1
(43) Pub. Date: Aug. 26, 2021

(54) Apparatus and Methods using hollow figures for storing edible products at a portable electronic device

(71) Applicants: Onyekachi Eke-Okoro, Williamstown, NJ (US); Amalachukwu Eke-Okoro, Williamstown, NJ (US)

(72) Inventors: Onyekachi Eke-Okoro, Williamstown, NJ (US); Amalachukwu Eke-Okoro, Williamstown, NJ (US)

(21) Appl. No.: 16/798,601

(22) Filed: Feb. 24, 2020

(51) Int. Cl. F16M 13/02; A45C 11/00

(52) U.S. Cl. CPC F16M 13/02; A45C 2011/002; A45C 11/00

(57) ABSTRACT

A storage arrangement can attach to a portable electronic device directly or through a frame that holds the device. Flexible hollow figures can releasably connect to the frame or the portable device, using various disclosed joint.s The hollow figures have an opening for gaming access to an internal storage chamber. The opening can be a slit that dilates when the figure is squeezed.

### BACKGROUND OF THE INVENTION

### 1. Field of the Invention

The present invention relates to storing edible products, and in particular, to storage at a portable electronic device.

### 2. Description of Related Art

Portable electronic devices are ubiquitous, and are provided as tablet computers, portable phones, handheld personal digital assistants, portable gaming devices, etc. These portable devices allow a wide variety of computing functions to be executed in almost any location chosen by the user. These portable devices can run programs such as conventional business applications, but can also run applications designed primarily for entertainment purposes. There are a wide variety of games that can be played against a computer or against another gamer or a large field of online gamers.

These portable electronic devices have become very popular with children. Children can watch videos, read stories, or interact with others on a social media platform Other applications allow a child to engage in entertaining activities such as drawing pictures, composing music, taking trivia quizzes, taking and modifying photographs, joining to dubs to celebrities that are well-known to children, etc.

To make these portable electronic devices more “child friendly,” it is desirable to decorate the protective case holding the electronic device to appeal to children. For example, images of popular cartoon characters can be used, it is generally desirable to expand this concept to make the device more toy-like and to provide accessories that children will want to use.

See also, U.S. Pat. Nos. 6,247,595; 7,431,161; 8,833,379; 9,560,903; and 9,755,685; as well as US Patent Application Pub. Nos. 2010/0122439; 2011/0089077; 2011/0303560; 201370148270; and 2018/G152216.

### SUMMARY OF THE INVENTION

In accordance with the illustrative embodiments demonstrating features and advantages erf the present invention, there is provided a storage arrangement tor attachment to a portable electronic device. The arrangement includes one or more hollow figures, each having a storage chamber and an opening for gaining access to the storage chamber. The arrangement also includes a frame adapted to connect to the portable electronic device. Each of the one or more hollow figures are adapted to releasably connect to the frame.

In accordance with another aspect of the invention a storage arrangement is provided for attachment to a portable electronic device. The arrangement includes a flexible hollow figure having a storage chamber for storing edible products. The figure has a slit that can open to allow access to the storage chamber. The figure is squeezably operable to dilate the slit. The arrangement also includes a U-shaped clip mounted on the hollow figure and adapted to mount alongside the portable electronic device edgewise.

In accordance with another aspect of the invention, a storage method is provided, which employs a hollow figure and a portable electronic device. The method includes the stop of mounting the hollow figure alongside the portable electronic device. The method also includes the step of storing edible products in the hollow figure.

A disclosed storage arrangement employs three dimensional figures that can be attached to a portable electronic device or to a frame that holds a portable electronic device The figure may portray an animal head, down head, a plaything, a hard, a limb, or otter object. The disclosed figures are hollow and have an opening that enables the user to store and retrieve items in the figure. In some cases the stored items can be edible items such as candies, small crackers, raisins, etc. The opening may be a slit on the front, back, top, or sidles of the figure.

The figure may be attached to a frame that has a back panel with an outline that is rectangular, triangular, or has other shapes. One disclosed back panel has on its upper and lower edge a grip per that can hook over opposite edges of the portable electronic device. This frame does not have side walls, and thus the portable electronic device can be slid into the grippers on the frame. In other instances the frame is in the form of a protective case closely mounted around the back and with walls that embrace the four edges of a portable electronic device.

The three dimensional figure can be attached in a variety of ways to a frame that holds a portable electronic device. For example, attachment may be by means of a ball and socket joint. The socket may be formed in the frame and a ball may project from the figure, or vice versa. In other embodiments, a keyhole-shaped slot may be formed in the frame and the figure may have a prong with an enlarged head the slides and locks into the keyhole slot. Again, the position of the keyhole slot and prong may be reversed in other embodiments.

In one disclosed embodiment, a figure has a U-shaped clasp that directly engages an edge of a portable electronic device, without a separate intervening structure or protective case.

Another disclosed embodiment has a spatially adjustable pair of grippers that can engage the opposing edges of a portable electronic device. These grippers are connected together by a pair of legs that are linked together at their midsections, in a scissor-like fashion. The back wall of the upper and lower grippers each have a slot at their left ends (but in some cases the slots will be of the right ends). The upper slot slidably connects to the upper end of one leg aid the lower end of the other leg slidably connects to the lower slot. Basically, one leg's upper (lower) end slides in the slot of the upper (lower) gripper and its lower (upper) end is pivotally connected to the lower (upper) gripper without the ability to slide. Accordingly, the slots and legs car accommodate changes in the spacing between the two grippers, while keeping the two grippers parallel.

The lower ends of these crossed tegs extend past the lower gripper and terminate in enlarged feet. These feel are canted and will tilt the portable electronic device into a reclining angle that makes its screen easy to read.

Another disclosed frame slidably supports a box with a lid that can be opened to store a sandwich. This arrangement has two pairs of interconnecting channels. One pair of channels has a first channel mounted on the box with a downwardly projecting flange, and the second channel is mounted on a frame having an upwardly projecting flange. Relative to this pair, the other pair of channels are inverted. Specifically this other par has a first channel on tie box with an upwardly projecting flange, and a second channel on the frame with a downwardly projecting flange.

In another disclosed embodiment a detachable figure car employ a bowl-like base. A lid hinged on the rim of the bowl can allow opening and closing of the bowl. The bowl-like base has a stem that can connect to the frame. The stem can axially reciprocate relative to the base, to allow movement toward and away from the frame. The stem also incorporates a hinge that allows the base to fold relative to the frame. The disclosed stem has a distal ball that can conned to a keyhole-shaped socket in the frame. This socket has a round hole and a relatively long slot. This long slot allows the stem and the base to slide relative to the frame. The bowl-like base can be disposed in various positions, and with the lid lifted, the bowl can be used for consuming edible products such as oatmeal or a breakfast cereal.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is a perspective view of a storage arrangement in accordance with principle of the present invention, and showing a figure connected to a frame in the form of a protective case;

FIG. 2 is an upper fragmentary view of the arrangement of FIG. 1 with the figure removed to show a figure connector;

FIG. 3 is a cross-sectional view of an upper fragment of the arrangement of FIG. 1 with the figure disconnected from the frame;

FIG. 4A is a front view of a figure that is alternate to that shown to FIG. 1;

FIG. 4B is a rear view of the figure of FIG. 4A;

FIG. 5A is a front view of a figure that is alternate to that shown in FIGS. 1 and 4A;

FIG. 5B is a rear view of the figure of FIG. 5A;

FIG. 6 is an elevational view of a figure that is an alternate to that shown in FIGS. 1, 4A, and 5A;

FIG. 7 is a perspective view of a frame that is an alternative to that shown in FIG. 1;

FIG. 8 is a fragmentary, perspective view of a lower portion of a figure having an implement designed to mate with the figure connector of FIG. 7;

FIG. 9 is a perspective view of a frame that is an alternative to those mentioned above;

FIG. 10 is a perspective view erf a frame that is similar to that of FIG. 9, but with an alternate, keyhole-shaped, figure connector;

FIG. 11 is a perspective view of a frame that is an alternative to those mentioned above;

FIG. 12 is a perspective view of an adjustable frame employing crossed legs, which is an alternative to the frames mentioned above;

FIG. 13 is a perspective view of the frame of FIG. 12, which has been adjusted to increase its height;

FIG. 14 is a perspective view of an alternative frame fitted with a sliding sandwich box;

FIG. 15 is a detailed, fragmentary view of a portion of the frame and box of FIG. 14;

FIG. 16 is a perspective view of a figure having a bowl-shaped base shown next to a frame with an elongate slot;

FIG. 17 is a detailed, exploded view of the stem of FIG. 16;

FIG. 18 is a perspective view of a stem that is an alternative to that shown in FIG. 17;

FIG. 19 is side, elevational view of the figure of FIG. 16 shown connected to the frame and schematically illustrated being repositioned;

FIG. 20 shows the figure of FIG. 19 having been fitted by virtue of the extension of the stem of FIG. 16;

FIG. 21 shows the figure of FIG. 20 having been swung 90° by use of the hinge of the stem of FIG. 16;

FIG. 22 shows the lid of FIG. 21 lifted to allow access to the storage chamber in the figure; and

FIG. 23 is a cross-sectional view of the figure of FIG. 22.

### DETAILED DESCRIPTION

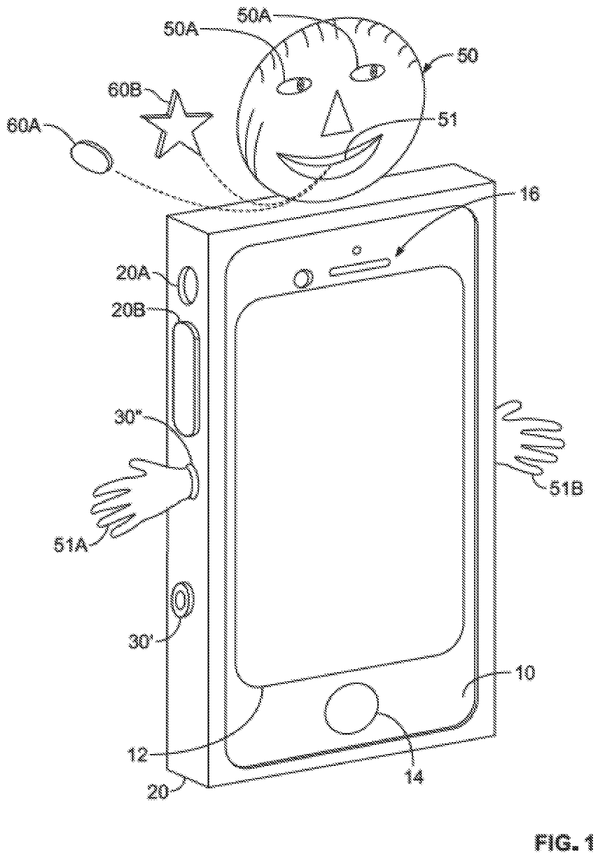

Referring to FIGS. 1-3, a storage arrangement is shown as a three dimensional figure 50 attached to the top of a frame 20, which frame holds a portable electronic device 10. Frame 20 is in the form of 3 protective case encompassing the back of the portable electronic device 10 and Its four peripheral surfaces (namely, the two lateral surfaces on the right and left, and the upper and lower surfaces).

Case 20 covers the periphery of the front of device 10, but leaves the front mostly open to allow viewing of screen 12 and to expose home button 14 and sensors 15. One edge of case 20 has an opening 20A for a mute switch (not shown) and a pliable abutment 2GB that allows opera ton of am underlying volume control (not shown).

FIG. 50 is hollow, and made mostly of a flexible material such as rubber, pliable plastic, or other elastomeric material. FIG. 50 is rounded and has on the front a number of facial features such as eyes 50A. FIG. 50 has an opening shown as a slot 51 positioned and shaped like a mouth. Slot 51 is an opening into the hollow interior of FIG. 50. This hollow interior serves as a storage chamber for storing edible products, in this case lozenge-shaped candy 60A and star-shaped candy 60B.

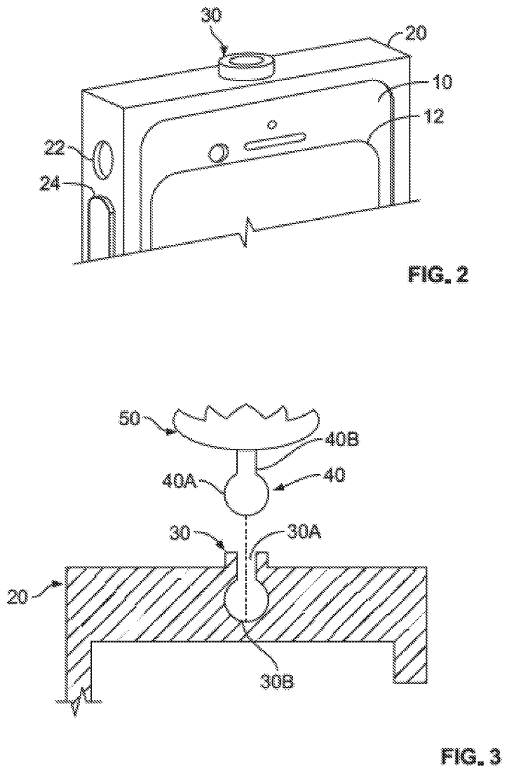

In FIGS. 2 and 3 three dimensional figure 50 has been removed from frame 20 to reveal features of figure connector 30 to this embodiment the inner end of inlet channel 30A leads to enlarged cavity 30B. The outer end of channel 30A has a short external collar. The underside of previously mentioned figure 50 has a projection 40 shown as a ball 40A at the end of stem 40B. The foregoing functions as a ball and socket joint in that bail 40A can travel through channel 30A and snap into cavity 30B (this joint can also be considered a snap joint).

Referring again to FIG. 1, the left side of case 20 is shown with a figure connector 30′ that is identical to figure connector 30 of FIGS. 2 and 3. Another identical figure connector 30″ is shown connected to three dimensional figure 51A, which is shaped to have the appearance of a human hand. The right side of case 20 has a similar arrangement with hand-shaped figure 51B shown projecting therefrom.

In operation, case 20 can be installed on portable electronic device 10 in the usual fashion. Thereafter, a user will select any one of a variety of decorative objects, such as hollow figure 50 and hands 51A and 51B. These decorative elements can be snapped into place and later removed (and if desired, replaced) using the ball and socket joint 30/40 shown in FIG. 3. With the decorative elements installed, the user can insert edible products 60A and 60B into mouth 51. Figure 50 can be squeezed horizontally to compress the figure and dilate mouth 51, making insertion of products 60A and 60B easier.

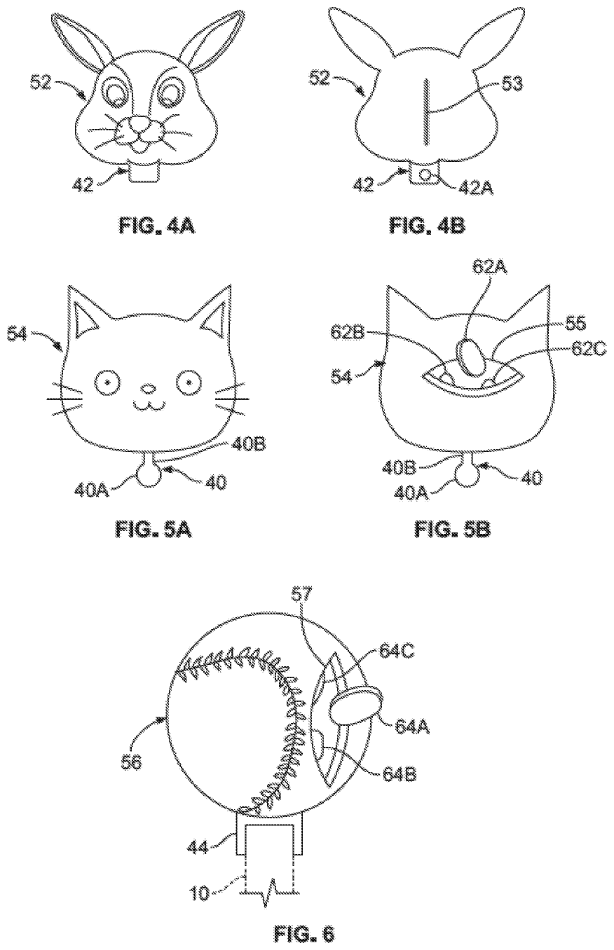

Referring to FIGS. 4A and 4B, three dimensional figure 52 is in the form of a rabbits head. Figure 52 is again hollow and made mostly of flexible materials. Slits 53 on the back of figure 52 leads to the storage chamber inside figure 52. Slit 53 can be opened by vertically squeezing figure 52, which will deform the figure and dilate the slit. Accordingly, the user wig then Ire able to store edible products or other objects inside figure 52. Connector 42 on the bottom of figure 52 has a tab with a ball 42A offset from the fab and designed to fit in the keyhole-shaped slot that will be described presently.

Referring to FIGS. 5A and 5B, three dimensional figure 54 is to the form of a cat's head. Figure 54 is again hollow and made mostly of flexible materials. Slit 55 on the back of figure 52 leads to the storage chamber inside figure 54. Slit 55 can be opened as shown by horizontally squeezing figure 54, which will deform the figure and dilate the slit. Accordingly, the user is able to store edible products 62A, 62B, and 62C (or other objects) inside figure 54. Connector 40 on the bottom of figure 54 is the same as connector 40 of FIG. 3 and therefore has the same reference numerate.

Referring to FIG. 6, three dimensional figure 56 is in the form of a baseball. Figure 56 is again hollow and made mostly of flexible materials. Slit 57 on the surface of figure 56 leads to the storage chamber inside figure 54. Slit 57 can be opened as show by vertically squeezing figure 56, which will deform the figure and dilate the slit. Accordingly, the user is able to store edible products 64A, 64B, and 64C (or other objects) inside figure 56.

U-shaped dip 44 on the bottom of figure 56 is designed to attach edgewise to portable electronic device 10 (shown in phantom in this view). White dip 44 attaches directly to device 10 in this embodiment, in other embodiments the dip can attach to a frame that holds the portable electronic device.

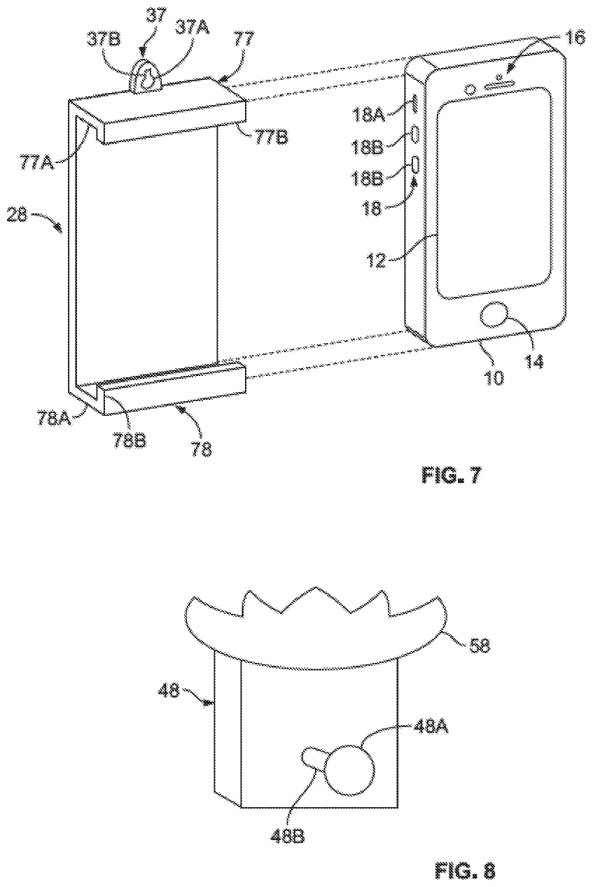

Referring to FIGS. 7 and 8, frame 28 is shown as a rectangular panel The upper edge of frame 28 has an upper gripper 77 show with a projecting tab 77A supporting an overhanging lip 77B. Lower gripper 78 on the bottom of frame 28 has a projecting shelf 78A supporting a lip 788. A first (upper) edge and a second (tower) edge of portable electronic device 10 can slide into the grippers 77 and 78. Device 10 is shown with previously mentioned home button 14 and sensors 16. Also shown here are controls 18, namely mute switch 18A and volume buttons 18B.

Mounted atop upper gripper 77 is a figure connector 37. Connector 37 is show as a rounded tab with a keyhole-shaped socket having a round hole 37A communicating with a channel 37B. In FIG. 8 a three dimensional figure 58 (only a fragment illustrated) has a connector 48 in the form of a rectangular tab. Connector 48 supports a projection shown as a spherical element 48A mounted on stem 48B. Connector 48 is substantially the same as connector 42 of FIG. 4B, both structurally and functionally.

In operation, element 48A can be inserted into round hole 37A (FIG. 7) and thereafter stem 48B (FIG. 8) can be slid upwardly m channel 37B (FIG. 7) to hold figure 58 in place. The insertion of element 48A car be either into the front or back of figure connector 37.

As before, the user can select any one of the variety of three-dimensional elements to install on figure connector 37 . In particular, figure 58 can use any of the designs shown in FIGS. 4A, 5A, or 6. Also as before, the chosen figure can be squeezed to dilate the associated slot to facilitate transfer of edible products relative to the figure.

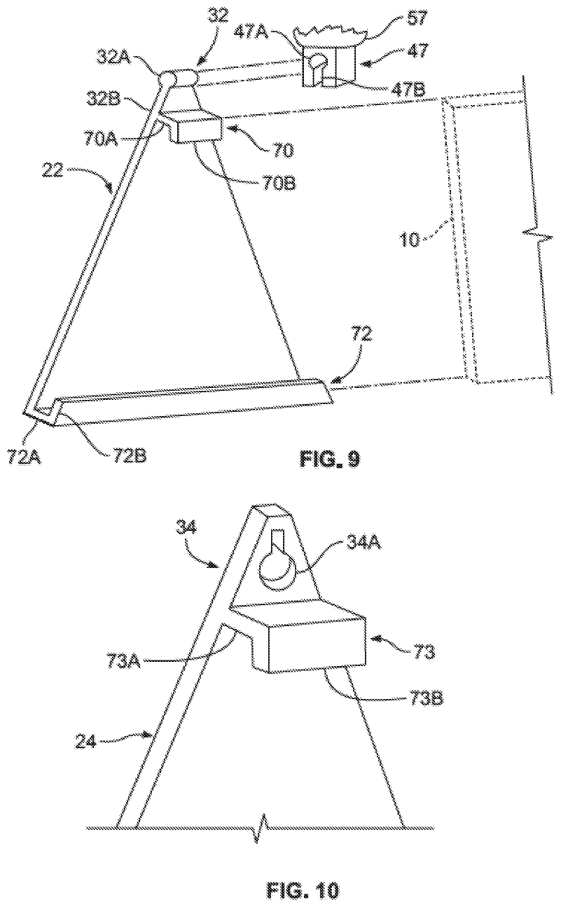

Referring to FIG. 9, frame 22 is shows as a triangular panel with a truncated upper tip. Tire upper tip has an upper gripper 70 shews as a projecting tab 70A supporting an overhanging lip 70B. The tower gripper 72 on the bottom of frame 22 has a projecting shelf 72A supporting an upright lip 72B. Lower gripper 72 extends over a greater distance than upper gripper 70. A first (upper) edge and a second (lower) edge of a portable electronic device 10 (device shown in phantom) can slide into the grippers 70 and 72.

The upper tip of frame 22 has a figure connector 32 with a tab 32B that upwardly projects and terminates in a cylindrical stub 32A with slanted Kids. Three dimensional figure 57 has a connector 47. Connector 47 has a keyhole-shaped slot with a channel 47B leading to a larger cylindrical chamber 47A. Previously mentioned stub 32A can slide into chamber 47A to hold figure 57 in place.

As before, any one of a variety of three-dimensional elements can be chosen for installation on connector 32 (see for example, the three dimensional figures of FIGS. 4A, 5A or 6). The chosen figure can be manipulated to transfer edible products relative to the figure

Referring to FIG. 10, frame 24 is almost the same as previously mentioned frame 22 (FIG. 9) and has a similar upper gripper 73 and a lower gripper (not shown). Frame 24 has a different figure connector 34, which has a triangular outline with a truncated tip. This triangular tip is pierced by keyhole-shaped socket 34A. Connector 48 of FIG. 8 can connect to socket 34A to the manner previously described to connection with FIG. 8. As before, any one of a variety of three-dimensional elements can be chosen tor installation on connector 34, and the chosen figure can be manipulated to transfer edible products relative to the figure.

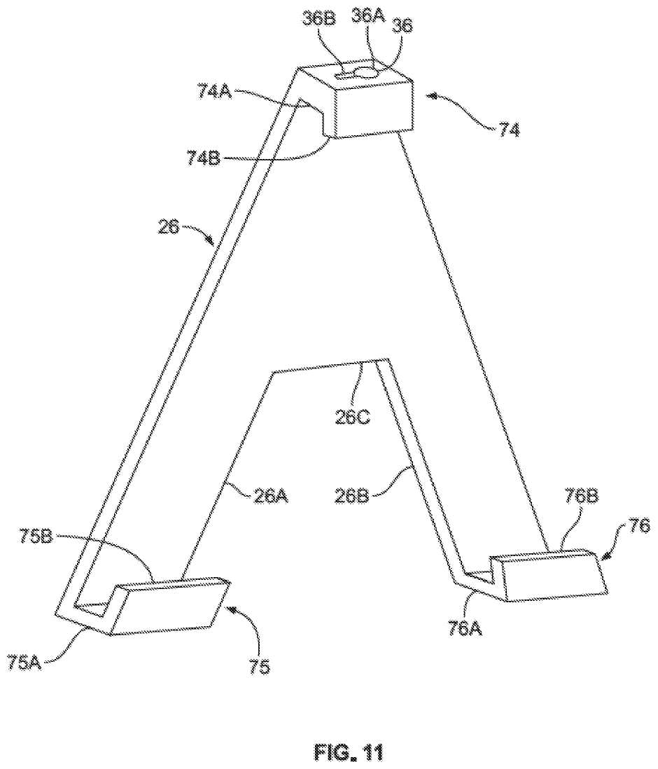

Referring to FIG. 11, frame 26 has a panel with a right and left edge that are disposed at an acute, upwardly converging angle. The bottom of frame 26 is interrupted by a notch that forms legs 26A and 26B. Legs 26A and 26B are disposed at an acute, upwardly converging angle and are located on ether side of horizontal, Inside edge 26C.

Frame 26 has a lower gripper in the form of a spaced pair of hooking members 75 and 76 at the bottom of tegs 26A and 26B, respectively. Hooking member 75 has a projecting shelf 75A supporting an upright lip 75B. Hooking member 76 has a projecting shelf 76A supporting an upright lip 76B.

Frame 26 has an upper gripper 74 shown as a preceding tab 74A supporting an overhanging lip 74B. Gripper 74, together with grippers 75 and 76, can hold a portable electronic device in the manner described in connection with FIGS. 7 and 9.

Upper gripper 74 also functions as a figure connector Specifically, keyhole-shaped socket 36 on tab 74A can receive one of the previously described projections. For example, ball 40A of FIG. 5A can be inserted into round bole 36A (FIG. 11) and slid to the left with stem 40B (FIG. 5A) sliding in channel 36B (FIG. 11). Internal clearance is provided allowing translation of bait 40A when stem 40B stales in channel 36B.

As before, any one of a variety of three-dimensional elements car be chosen for installation on connector 36. and the chosen figure can be manipulated to transfer edible products relative to the figure.

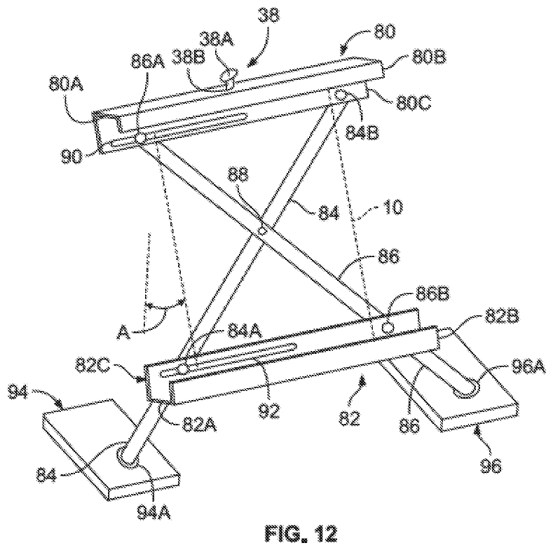

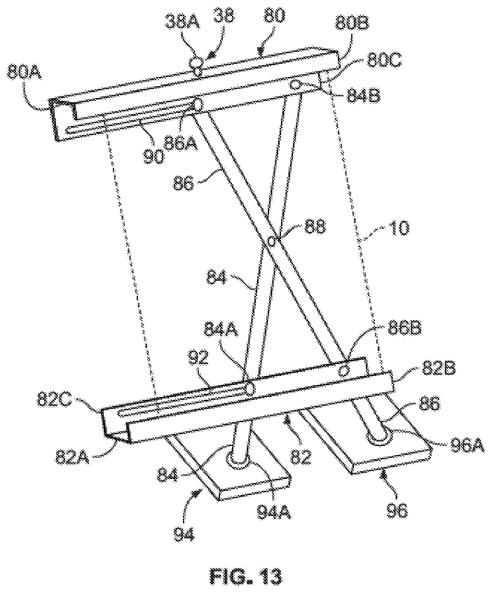

Referring to FIGS. 12 and 13, the illustrated frame has a crossed pair of legs 84 and 86 connecting between an upper gripper 80 and tower gripper 82. Upper gripper 80 has a rear wall 80C supporting a shelf 82A, which in turn supports a dependent lip 80B. The left portion of wall 80C has an upper longitudinal slot 90. Lower gripper 82 has a rear wail 82C supporting a shelf 82A, which to turn supports upright lip 82B. The left portion of wall 82C has a lower longitudinal slot 92.

Legs 84 and 86 are pivotally connected together at their midsections by pin 88, which is located at the crossing of the two legs. The upper end of leg 84 is attached by pin 848 to wail 80C. The tower end of leg 84 is slidably mounted by pin 84A to slot 92. The tower end of leg 86 is attached by pin 86B to wall 82C. The upper end of leg 86 is slidably mounted by pin 86A to slot 90. Legs 84 and 86 are referred to herein as an adjustable assembly with leg 84 being considered the first one of the tegs and leg 86 the other one of the legs.

A portable electronic device 10 (stows to phantom) can slide into the grippers 80 and 82 in a manner similar to that described in connection with FIG. 7.

Figure connector 38 has a stem 388 projecting from shelf 80A and supporting ball 38A FIG. connector 38 can snap into a snap joint, such as socket 30 of FIG. 3. This resulting joint of FIG. 12 is basically a bait joint that is the inverse of that shown in FIG. 3.

The lower aid of leg 84 (86) attaches to joint 94A (96A) in lower foot 94 (96). Legs 84 and 86 are mounted in feet 84 and 86 to tit track slightly. This places device 10 at a reclining angle A relative to vertical. In this embodiment, joints 94A and 96A allow angular adjustment erf legs 84 and 86 and thus adjustment of the reclining angle A.

In operation, the spacing between grippers 80 and 82 can be adjusted by changing the angle between legs 84 and 86. In comparison to FIG. 12, in FIG. 13 the upper ends (as well as the tower ends) of legs 84 and 86 are brought closer together to increase the spacing between grippers 80 and 82. To accomplish this repositioning, the ends of legs 86 aid 84 slide to their respective slots 90 and 92.

As shown in FIG. 13, the angular repositioning of legs 84 and 86 increases the spacing between grippers 80 and 82. Accordingly, a taller, portable electronic device 10′ (shown in phantom) can be mounted as illustrated between grippers 80 and 82.

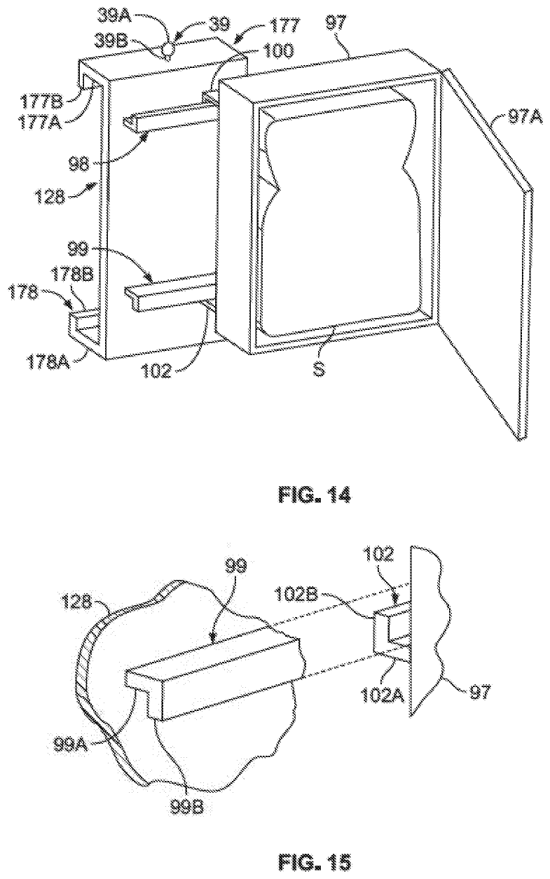

Referring to FIGS. 14 and 15, frame 128 is substantially the same as frame 28 of FIG. 7, and corresponding components have the same reference numerals but increased by 100.

On the other hand, this embodiment of FIG. 14 uses a different figure connector 39, shown mounted atop shelf 177A. Connector 39 has a stem 39B projecting from shelf 177A and supporting ball 39A. Essentially, connector 39 is structurally and functionally the same as connector 38 of FIG. 12.

Box 97 has a door 97A in front and is slidably connected on its back to the rear face of frame 128. As shown in FIG. 15, box 97 has a hook-like element with a shelf 102A supporting an upright lip 1028. Frame 128 has a mating, hook-like element 99 with a shelf 99A supporting a dependent lip 998. Shelf 99A slides over lip 102B with lip 99B located to the inside of lip 102B.

Hook-like element 98 on the back of frame 128 (FIG. 14) is upside down in comparison to element 99. Book-like element 100 on the back of box 97 is upside down relative to element 102. Basically, elements 98 aid 100 have lips that interlock in the same way as the previously mentioned fix lips 998 and 102B (FIG. 15). Accordingly, box 97 can slide back and forth relative to frame 128.

In operation, door 97A can be opened in order to store sandwich S in box 97. After door 97A is dosed, box 97 can be slid into a position centered around (or if desired, offset from) frame 128.

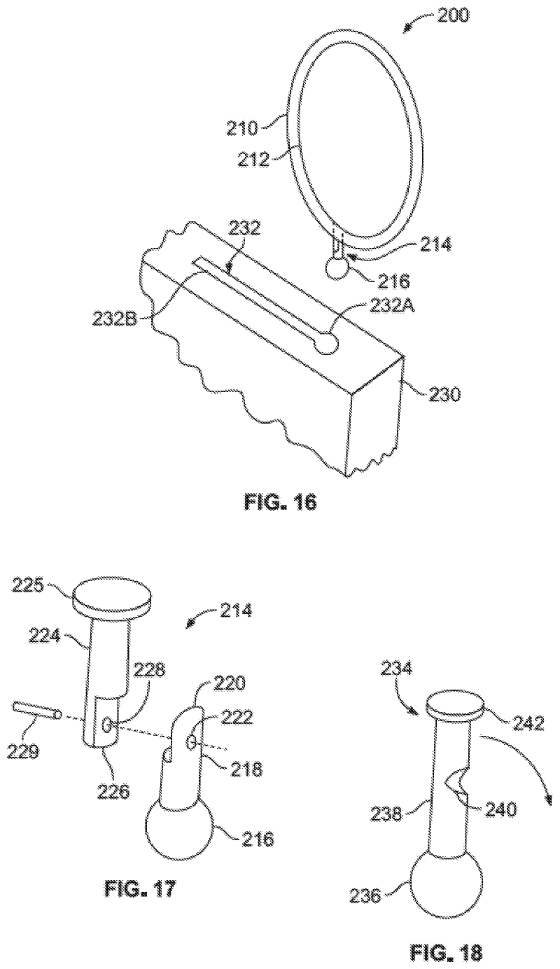

Referring to the storage arrangement of FIGS. 16 and 23, hollow figure 200 has a circular, bowl-shaped base 210 with a circular lid 212. It will be appreciated that instead of circular shapes, some embodiments may have outlines that are oval, polygonal, or other shapes.

As shown in FIG. 23, lid 212 is hinged (live hinge) to the circular rim of base 210. With lid 212 lifted as shown, base 210 can act as a bowl to hold edible products 211, for example, oatmeal, or a breakfast cereal immersed in milk. When base 210 is empty and dean, lid 212 can be closed over the opening in the base. In this embodiment figure 200 is made of flexible materials.

Referring to FIGS. 16 and 17, stem 214 is shown projecting from an edge of base 210. Stem 214 is mounted to allow it to reciprocate axially in base 210. In FIG. 17, ball 216 is shown integrally attached to the distal end of lower shaft 218. Upper shaft 224 has cm its proximal end flange 225, and on its distal end a flat (notch) 226 that will normally overly the Hat 220 on the proximal end of shaft 218. Flats 220 and 226 have through holes 222 and 228, respectively, that are connected together by pin 229 to provide a hinge between shafts 218 and 224. Basically, shaft 218 can rotate plus or minus 90° relative to shaft 224. Range 225 acts as a stop preventing withdrawal of stem 214 from base 210.

Referring to FIG. 18, the illustrated, alternate stem 234 has a shaft 238 with a flange 242 on its proximal end and on its distal end a ball 236. Shaft 238 can deflect 90° about notch 240, which acts as a hinge. The stem of FIG. 18 is a substitute for that shown in FIG. 17. Components of stem 234 corresponding to those of FIG. 17 have the same reference numerals, but increased by 100.

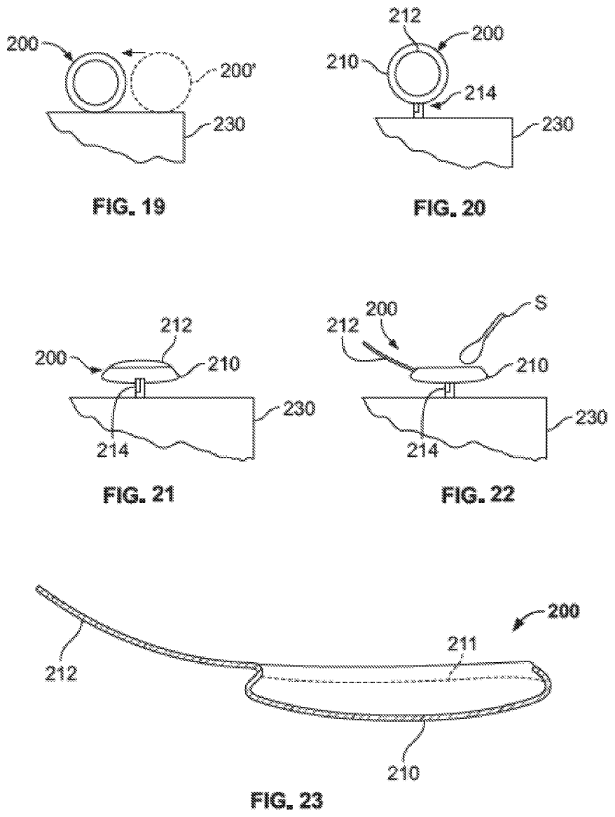

Referring to FIGS. 16, 17, and 19, frame 230 is similar to frame 20 of FIG. 1, and will again be used to hold a portable electronic device. However, frame 20 has a Keyhole-shaped socket 232 (FIG. 16) with a round hole 232A merging with an elongate slot 232B. Socket 232 car be mounted on any edge of frame 230 (right, left top or bottom). Ball 216 can be inserted through round hole 232A and then stem 214 can Slide along the length of slot 232B. Accordingly, as shown in FIG. 19, figure 200 can be repositioned, that is, moved from the position shown in phantom (position 20o′) to the left, arriving at the position shown in full lines. To allow significant repositioning, elongate slot 232B is at least three times longer than stem 214. Also, figure 200 can be rotated about the axis of stem 214.

Referring to FIG. 20, figure 200 has been lifted away from frame 230, which causes stem 214 to extend from figure 200 as shown.

Referring to FIGS. 17 and 21, figure 200 has been folded back, which folding has bear accommodated by the rotation between shafts 218 and 224 (FIG. 17). It will also be appreciated that in this folded condition stem 214 will allow continuous, yaw-like rotation of figure 200 so it can extend to either side of frame 230 or along its length, in any direction.

Referring to FIGS. 22 and 23, lid 212 has been lilted from base 210 to expose the opening in the base and to allow the transfer of edible material 211 relative to the bowl-like base 210. The edible contents 211 can be consumed using spoon S. When edible product 211 has been removed and the base 210 cleaned, lid 212 can be dosed over the opening to base 210. Thereafter the foregoing steps can be reversed (that is. FIG. 21. followed by FIG. 20, and then FIG. 19).

It will be appreciated that stem 214 can be slid to the right along slot 232B of socket 232 (FIG. 16), before removing ball 216 through round hole 232A. Since figure 200 can be releasably connected to socket 232, the socket acts as a figure connector.

It is appreciated that various modifications may be implemented with respect to the above described embodiments. The dimensions of the foregoing storage arrangements can be varied to accommodate different types of electronic devices, such as portable phones, tablet computers, game controllers, etc. These arrangements can be designed to hold the portable electronic device in ether a portrait or landscape orientation. The three dimensional figures may represent various items, such as legs (human or animal), purses, finger rings, sporting goods, animal horns, vehicles, cups, geometric shapes (e.g., stars, concentric circles, ovals, polygons, etc.), cartoon characters, superheroes, celebrities, company logos, etc. Instead of using slits to access the storage compartment, some embodiments may employ folding flaps, cruciform slits, overlapping leafs, etc. Also, some embodiments may offer a storage compartment in the form of a pocket. Some embodiments may provide dimensional adjustability with telescoping rods, elastic members, straps with buckles, etc. Various other figure connectors are contemplated, including hook and loop fasteners, releasable adhesives, tongue and groove joints, dovetail joints, markets, tying cords into eyelets, alligator clips, screws in threaded holes, etc. Instead of holding the portable electronic device with overlying lips, some embodiments may employ hook and loop fasteners, releasable adhesives, comer brackets, opposing spring-biased walls tor gripping the edges of the portable device, elastic bands, etc.

Obviously, many modifications and variations of the present invention are possible in light of the above teachings. It is therefore to be understood that within the scope of the appended claims, the invention may be practiced otherwise than as specifically described.

1. A storage arrangement tor attachment to a portable electronic device, the arrangement comprising:
one or more hollow figures, each having a storage chamber and an opening for gaming access to the storage chamber, and
a frame adapted to connect to the portable electronic device, each of the one or more hollow figures being adapted to releasably connect to the frame.

2. A storage arrangement according to claim 1 wherein the frame has one or more figure connectors, each of the erne or more hollow figures being adapted to releasably connect to each of the one or more figure connectors.

3. A storage arrangement according to claim 1 wherein the frame has a plurality of figure connectors, each of the one or more hollow figures being adapted to releasably connect to each of the plurality of figure connectors.

4. A storage arrangement according to claim 1 wherein the storage chamber is adapted to hold edible products.

5. A storage arrangement according to claim 1 wherein each of the one or more hollow figures is mostly made of flexible material.

6. A storage arrangement according to claim 5 wherein each of the one or more hollow figures has a slit and can be squeezed to dilate the slit.

7. A storage arrangement according to claim 6 wherein one of the one or more figures has a front and back, the slit being located on either the front or the back.

8. A storage arrangement according to claim 6 wherein one of the one or more figures has a side, the slit being located on the side.

9. A storage arrangement according to claim 6 wherein at least one of the one or more figures is adorned with facial features.

10. A storage arrangement according to claim 9 wherein the slit is located to represent a mouth among the facial features.

11. A storage arrangement according to claim 1 wherein one of the one or more figures has a U-shaped clip adapted to embrace and attach edgewise to the frame.

12. A storage arrangement according to claim 1 wherein one of the one or more figures is adapted to releasably attach to the frame by means of a bail and socket joint.

13. A storage arrangement according to claim 1 wherein one of the one or more figures is adapted to releasably attach to the frame by means of a snap joint, the snap joint having an inlet channel communicating with an enlarged cavity.

14. A storage arrangement according to claim 1 wherein the frame has a keyhole-shaped socket, one of the one or more figures has a projection tor attachment to the keyhole-shaped socket.

15. A storage arrangement according to claim 1 wherein one of the one or more figures has a keyhole-shaped socket, the frame having a projection for attachment to the keyhole-shaped socket.

16. A storage arrangement according to claim 2, wherein the frame has four peripheral surface including an upper and tower surface and two lateral surfaces, the figure connectors being at least two in number and being mounted on different ones of the four peripheral surfaces.

17. A storage arrangement according to claim 1 whereto the frame includes:
an upper gripper sized to hook around a first edge of the portable electronic device; add
a lower gripper sized to hook around a second edge of the portable electronic device.

18. A storage arrangement according to claim 17 wherein the upper and the lower grippers are open on at least one end to allow the portable electronic device to slide onto the upper and the tower grippers.

19. A storage arrangement according to claim 17 wherein the lower gripper extends over a greater distance than the upper gripper.

20. A storage arrangement according to claim 17 whereto the tower gripper has a spaced par of hooking members.

21. A storage arrangement according to claim 17 wherein the frame comprises:
an adjustable assembly connected between the upper and the lower gripper and operable to adjust the spacing between them.

22. A storage arrangement according to claim 21 wherein the adjustable assembly comprises a crossed pair of legs pivotally connected at a crossing of the pair of legs.

23. A storage arrangement according to claim 22 wherein the upper gripper and the lower griper have an upper slot and tower slot, respectively, a first one of the pair of legs being connected between the upper gripper aid the tower slot, the other one of the pair of legs being connected between the lower gripper and the upper slot.

24. A storage arrangement according to claim 22 wherein each of the pair of legs has a lower foot oriented to keep the frame upright at a reclining angle.

25. A storage arrangement according to claim 1 comprising:
a box slidably mounted on the frame and sized to hold a sandwich.

26. A storage arrangement according to claim 1 wherein the one or more hollow figures comprises:
a bowl-shaped base having a ran encircling an opening, the base having a lid hinged to the rim, the lid being operable to pivot on the rim to allow access to edible product held in the base.

27. A storage arrangement according to claim 26 wherein the base comprises:
a stem adapted to releasably connect to the frame, the stem having a hinge arranged to allow the figure to pivot relative to the frame when the stem is connected to the frame.

28. A storage arrangement according to claim 27 wherein the frame has a figure connector with an elongate slot, the slot being more that three times longer than the stem, the stem being adapted to connect to the slot aid slide therein to allow repositioning of the base, the stem being mounted to reciprocate axially in the base to provide an adjustable extension from the base.

29. A storage arrangement for attachment to a portable electronic device composing:
a flexible hollow figure having a storage chamber for storing edible products, the figure having a slit that can open to allow access to the storage chamber, the figure being squeezably operable to dilate the slit; and
a U-shaped clip mounted on the hollow figure and adapted to mount alongside the portable electronic device edgewise.

30. A storage method employing a hollow figure and a portable electronic device, comprising the steps of:
mounting the hollow figure alongside the portable electronic device; and
storing edible products in the hollow figure.

31. A method according to claim 30 employing a frame and wherein the hollow figure is flexible and has a slit, the method inducing fire steps of:
mounting the portable electronic device on the frame;
attaching the hollow figure to ire frame;
squeezing the hollow figure to open the slit; and
transferring edible products throng the slit.
